(19) United States
(12) Patent Application Publication
(10) Pub. No.: US 2014/0373956 A1
(43) Pub. Date: Dec. 25, 2014

(54) Laminated Pipe Lining System

(71) Applicant: Jeffrey M. Tanner, Zanesville, OH (US)

(72) Inventor: Jeffrey M. Tanner, Zanesville, OH (US)

(21) Appl. No.: 14/311,691

(22) Filed: Jun. 23, 2014

Related U.S. Application Data
(60) Provisional application No. 61/838,639, filed on Jun. 24, 2013.

(51) Int. Cl. F16L 55/165

(52) U.S. Cl. CPC F16L 55/165
USPC 138/97; 138/141

(57) ABSTRACT

A laminated pipe lining system reduces or eliminates the risk of liner and seam failure due to stress and eases installation in small diameter pipes or pipes with multiple bends. The present invention generally includes a plurality of liners which are layered to line the inner surface of a conduit such as a utility pipeline. Each of the liners will generally include its own seam which is a product of the fabrication of the liners. The first liner is first inserted through the conduit and cured against the inner surface of the conduit. The second liner may then be inserted through the first liner and cured against its inner surface. The third liner may then be inserted through the second liner and cured against its inner surface. Each of the seams will be radially offset with respect to each other to protect the structural integrity of the lining system.

### CROSS REFERENCE TO RELATED APPLICATIONS

I hereby claim benefit under Title 35, United States Code, Section 119(e) of U.S. provisional patent application Ser. No. 61/838,639 filed Jun. 24, 2013. The 61/838,639 application is currently pending. The 61/838,639 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a conduit lining system and more specifically it relates to a laminated pipe lining system reduces or eliminates the risk of liner and liner seam failure due to stress and eases installation in small diameter pipes or pipes with multiple bends.

2. Description of the Related Art

Any discussion of the related art throughout the specification should in no way be considered as an admission that such related art is widely known or forms part of common general knowledge in the field.

Cured-in-place pipe (CIPP) lining has been used for many years for the rehabilitation of sewer and drain gravity piping, among other conduits. It is now being offered for water piping, process piping, and other types of pressure piping. However, the increased usage of such CIPP lining systems has revealed a number of issues present in such installations.

The majority of current CIPP liners are manufactured with a seam which can be a weak point of the liner. Depending on the manufacturer, some manufacturers overlap the lining materials to form a seam and others meet the lining material ends together without an overlap to create a seam. Under stress or strain, the seamed area can become compromised and cause the liner to fail. This weak point is especially a concern when lining pressure piping. Some lining manufacturers try and overcome this weakness by making the liner thicker for strength. This creates a new problem when trying to install the liner inside of small diameter piping or piping with multiple bends, especially with ninety degree bends. The thickness of the materials hinders the liner installation and can make it impossible to line the pipe

Because of the inherent problems with the related art, there is a need for a new and improved laminated pipe lining system which reduces or eliminates the risk of liner and liner seam failure due to stress and eases installation in small diameter pipes or pipes with multiple bends.

### BRIEF SUMMARY OF THE INVENTION

The invention generally relates to a laminated lining system and method which includes a plurality of liners which are layered to line the inner surface of a conduit such as a utility pipeline. Each of the liners will generally include its own seam which is a product of the fabrication of the liners. The first liner is first inserted through the conduit and cured against the inner surface of the conduit. The second liner may then be inserted through the first liner and cured against its inner surface. The third liner may then be inserted through the second liner and cured against its inner surface. Each of the seams will be radially offset with respect to each other to protect the structural integrity of the lining system.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a cross-sectional view of the present invention taken along line 2-2 of FIG. 1.

FIG. 3 is a side sectional view of a first liner being installed within a conduit.

FIG. 4 is a side sectional view of a second liner being installed within the first liner.

FIG. 5 is a side sectional view of a third liner being installed within the second liner.

FIG. 6 is a side sectional and exploded view of the present invention installed within a conduit.

FIG. 7a is an upper perspective view of a first liner installed within a conduit having a bend.

FIG. 7b is an upper perspective view of a second liner installed within a conduit having a bend.

FIG. 7c is an upper perspective view of a third liner installed within a conduit having a bend.

FIG. 8 is a flow chart illustrating the overall operation of the present invention.

### DETAILED DESCRIPTION OF THE INVENTION

### A. Overview

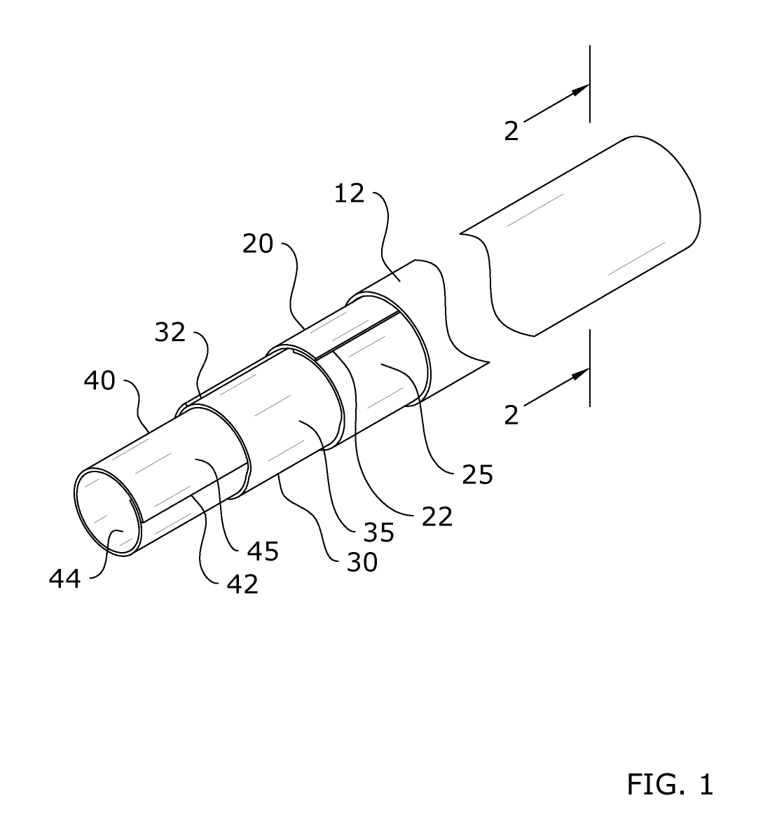

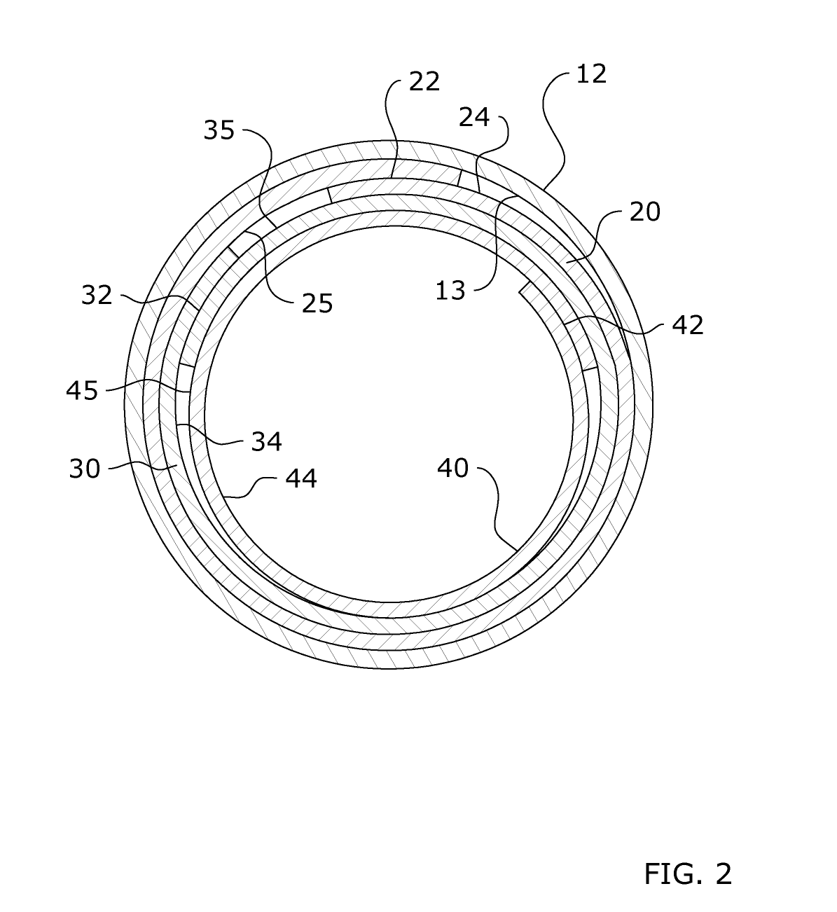

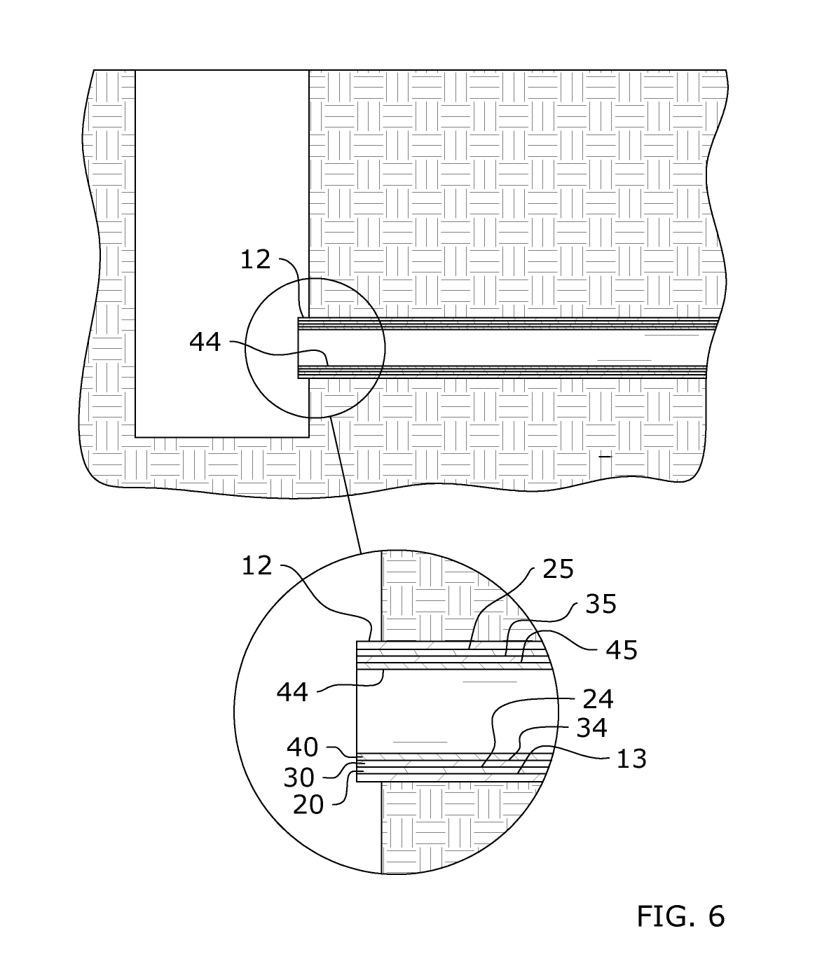

Turning now descriptively to the drawings, in which similar reference characters denote similar elements throughout the several views, FIGS. 1 through 8 illustrate a laminated pipe lining system 10, which comprises a plurality of liners 20, 30, 40 which are layered to line the inner surface 13 of a conduit 12 such as a utility pipeline. Each of the liners 20, 30, 40 will generally include its own seam 22, 32, 42 which is a product of the fabrication of the liners 20, 30, 40. The first liner 20 is first inserted through the conduit 12 and cured against the inner surface 13 of the conduit 12. The second liner 30 may then be inserted through the first liner 20 and cured against its inner surface 24. The third liner 40 may then be inserted through the second liner 30 and cured against its inner surface 34. Each of the seams 22, 32, 42 will be radially offset with respect to each other to protect the structural integrity of the lining system 10.

### B. Conduit

As shown throughout the figures, the present invention is utilized to line an inner surface 13 of a conduit 12 with a plurality of layered liners 20, 30, 40. The methods and systems described herein may be utilized in combination with a wide variety of conduits 12 adapted to transport any number of elements (i.e. gas, fluids, solids, etc.) The exemplary figures herein should not be construed as limiting on the scope of the potential types and configurations of conduits 12.

Generally, the conduit 20 will be comprised of underground piping which extends through its own bore hole. While the present invention is well-suited for installation of liners 20, 30, 40 within previously-installed conduit 12, the methods and systems described herein may also be utilized in new installations of conduit 12.

The conduit 12 includes an inner surface 13 through which the elements will be transported. The inner surface 13 of the conduit 12 will often become degraded over time through repeated usage of the conduit 12. The use of liners 20, 30, 40 may be used to prevent or repair such degradation. The liners 20, 30, 40 may be installed therein using a wide range of methods known in the art, including those mentioned herein. The liners 20, 30, 40 will cover the inner surface 13 of the conduit 12 so as to prevent and/or repair any damage to the inner surface 13.

### C. Laminated Liners

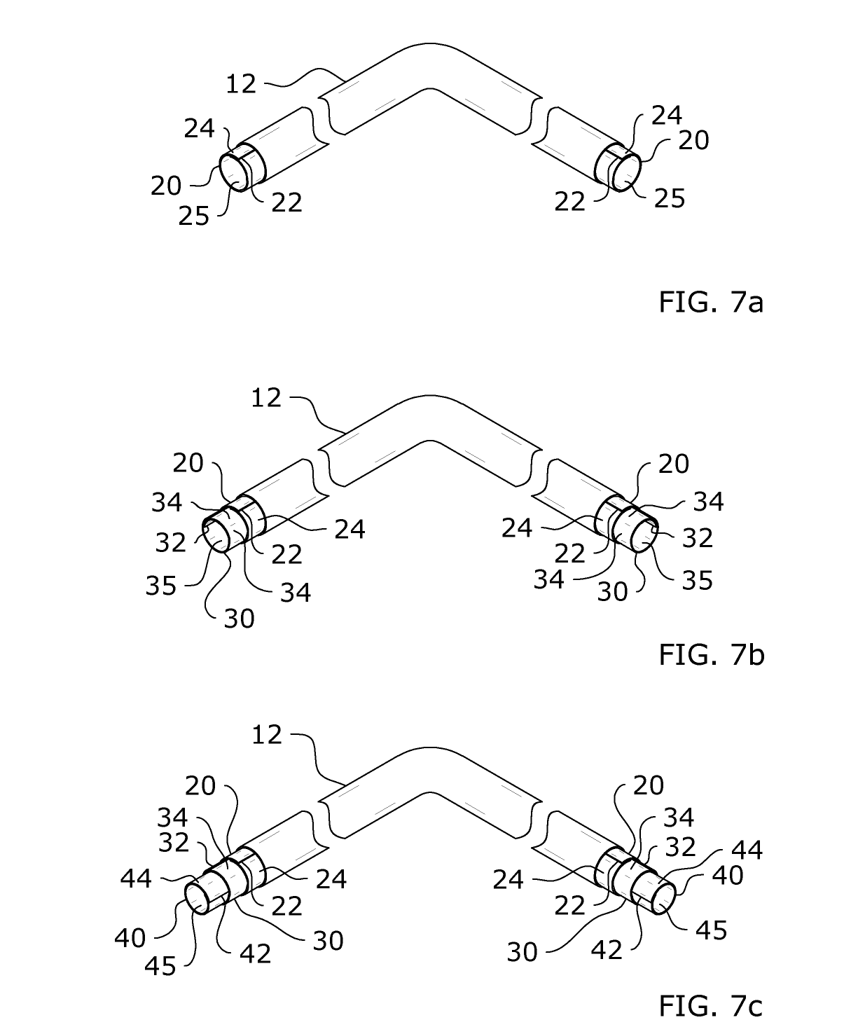

As shown throughout the figures, rather than utilizing a single cured-in-place pipe liner as is customary in the prior art, the present invention utilizes a plurality of liners 20, 30, 40 which are cured against each other within a conduit 12 to improve the durability of pipe lining. This unique laminating process also aids in allowing the liners 20, 30, 40 to traverse bends, such as 90 degree angles as shown in FIGS. 7a, 7b, and 7c.

The figures illustrate the usage of a first liner 20, a second liner 30, and a third liner 40. However, the number of liners 20, 30, 40 may vary in different embodiments. In some embodiments, only a first liner 20 and second liner 30 will be utilized. In other embodiments, additional liners 40 may be included. The number of liners 20, 30, 40 will be dependent on a number of factors, including the type of material used for the liners 20, 30, 40, the thickness of the liners 20, 30, 40, and the type of conduit 12 being lined.

It should be appreciated that various types of liners 20, 30, 40 may be utilized with the present invention. The liners 20, 30, 40 are generally inserted through a conduit 20 and expanded therein to seal against the inner surface 13 of the conduit 20. The inner surfaces 24, 34, 44 of the liners 20, 30, 40 will be adapted to allow whatever material is being transported to traverse the conduit 12 without causing damage to the inner surface of the conduit 12.

The liners 20, 30, 40 will generally comprise cylindrical tubes as shown throughout the figures. It should be appreciated that the liners 20, 30, 40 may comprise different shapes and/or configurations in alternate embodiments. Thus, the present invention should not be construed as limited to the cylindrical liners 20, 30, 40 shown in the figures.

The liners 20, 30, 40 may be comprised of various materials, including but not limited to felt or fleece textile-type materials which are customarily used in pipe lining. The scope of the present invention should not be construed as being limited to any particular type of liners 20, 30, 40, so long as the liners 20, 30, 40 may be installed along the inner surface 13 of a conduit 12 for protection and/or rehabilitation.

In some embodiments, the liners 20, 30, 40 may include a membrane made of polyurethane, polyvinylchloride, or other types of impregnable membranes. Some liners 20, 30, 40 may also have a layer of reinforcement-type material such as fiberglass to improve the strength of the liners 20, 30, 40. The liners 20, 30, 40 may thus be comprised of various materials such as but not limited to non-woven polyester felt, fiber reinforced fabric, polyester felt, glass reinforced polyester felt, glass fiber structured fabric, circular woven polyester fiber hose, woven hose plus felt, and woven hose plus felt and structured glass fiber fabric.

The liners 20, 30, 40 may be inserted through either the full length or a partial length of the conduit 12 using a wide range of methods known in the art. The liners 20, 30, 40 are generally pulled, pushed, or inverted into an existing host conduit 12 prior to being cured by ambient air, hot water, or steam. The liners 20, 30, 40 may be impregnated with a thermosetting resin. Various methods known in the art may be utilized for the installation of the liners 20, 30, 40 within the conduit 12 so long as the liners 20, 30, 40 are layered with each other with offset seams 22, 32, 42 as discussed herein.

The liners 20, 30, 40 may each be formed by being sewn, heat-seamed, or both sewn and heat-seamed to form the cylindrical tube configuration shown in the figures. The fabrication of the liners 20, 30, 40 may vary in different embodiments of the present invention. However, as is customary with such liners 20, 30, 40, each of the liners 20, 30, 40 will generally include a seam 22, 32, 34 which extends along the length of each liner 20, 30, 40.

As is best shown in FIG. 1, the first liner 20 includes a first seam 22, the second liner 30 includes a second seam 32, and the third liner 40 includes a third seam 42. Any additional liners included will similarly have seams. The seams 22, 32, 42 are common in liners 20, 30, 40 due to their construction. These seams 22, 32, 42 are typically aligned with each other in prior art installations, which can lead to total failure of the lining system and thus degradation of the conduit 12 the liners 20, 30, 40 were meant to protect.

As shown throughout the figures, the seams 22, 32, 42 of each liner 20, 30, 40 will be offset with respect to each other. In a preferred embodiment, the first seam 22 will be radially offset with respect to the second and third seams 32, 42. Preferably, at least 20 degrees will radially separate each seam 22, 32, 42 from the other seams 22, 32, 42.

It should be appreciated that some embodiments may include radial offsets of less than 20 degrees, while other embodiments may include radial offsets of greater than 20 degrees. It should also be appreciated that the degrees of separation between the seams 22, 32, 42 may vary between each seam 22, 32, 42. For example, the radial offset between the first and second seams 22, 32 may be different from the radial offset between the second and third seams 32, 42.

### D. Operation of Preferred Embodiment

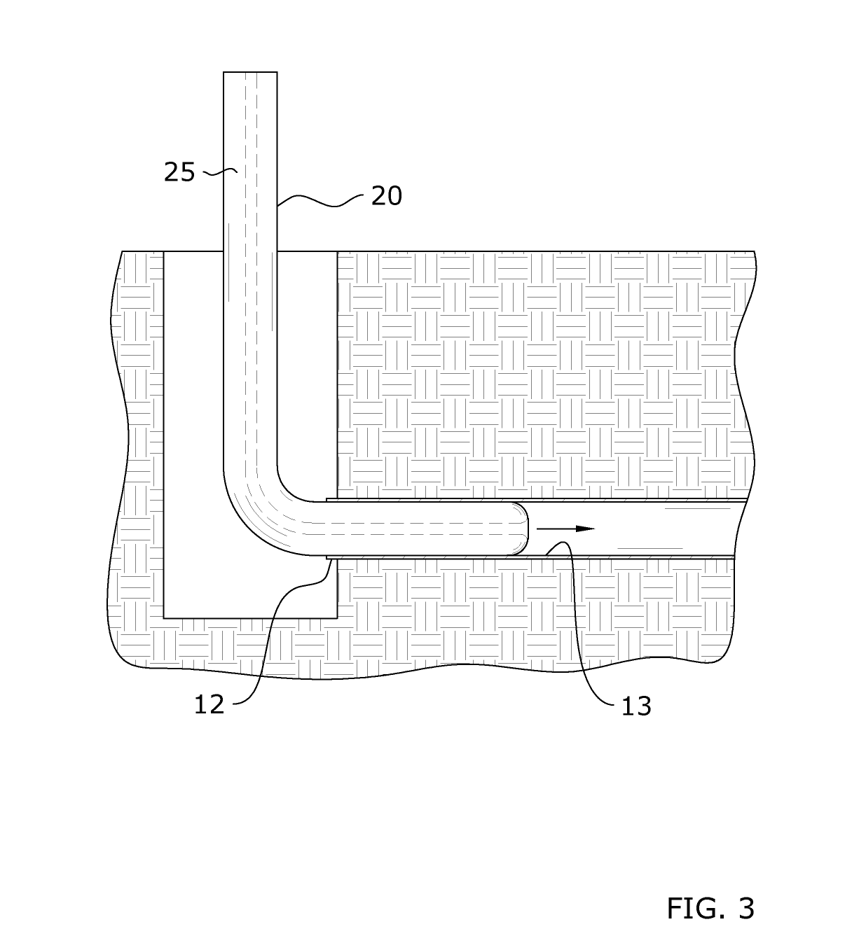

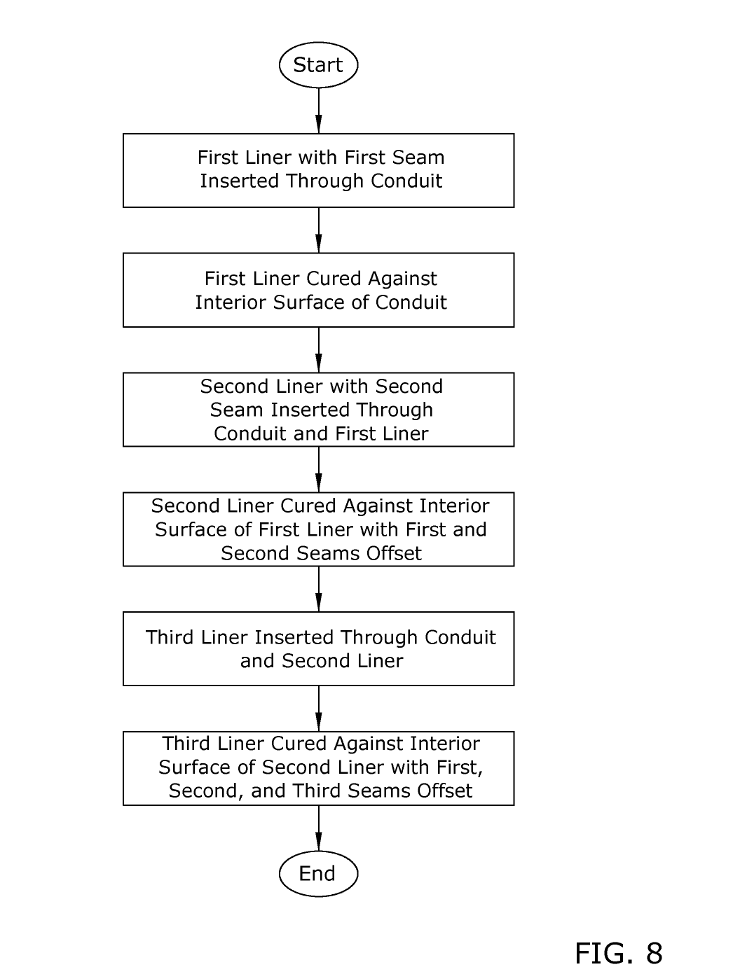

FIG. 8 shows an exemplary flow chart illustrating the overall operation of installation of the present invention. In use, the first liner 20 is inserted through the inner portion 13 of the conduit 12 as shown in FIG. 3. The first liner 20 may extend for part of the length of the conduit 12 or may extend for the full length of the conduit 12. The first liner 20 is then expanded such that the outer surface 25 of the first liner 20 seals against the inner surface 13 of the conduit 12.

A wide range of methods may be utilized to insert and expand the first liner 20 within the conduit 12. The first liner 20 may be installed within the conduit 12 (e.g. pipe, gas pipelines, water pipelines, sewer pipelines, and the like) by several methods including pulling in place, pushing in place or by inversion into the conduit 12. The first liner 20 is then expanded with ambient air, hot water or steam 20 to seal it against the inner surface 13 of the conduit 12 and cured. The use of a calibration bladder may be used, which would be inserted inside the first liner 20 then expanded against the inner surface 34 of the first liner 20 with ambient air, hot water or steam for curing of the liner 20.

After the first liner 20 is inserted within the conduit 12, the first liner 20 will be thermally cured against the conduit 12. Steam, ambient air, heated water, and the like may be used 20 to push the outer surface 25 of the first liner 20 against the inner surface 13 of the conduit with or without the use of a calibration bladder 12. Steam, ambient air or hot water is forced through the interior of the first liner 20 which expands the first liner 20 and presses its outer surface 25 against the inner surface 13 of the conduit 12. Thermosetting resin or the like will cause the first liner 20 to be sealed within the conduit 12 to protect its inner surface 13.

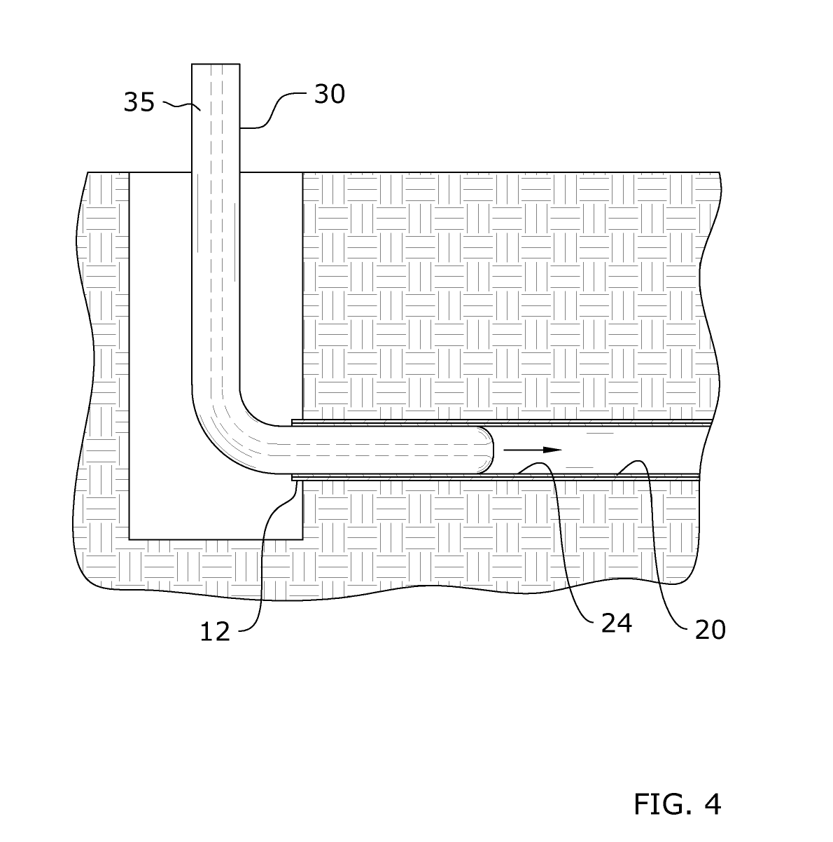

After sealing the inner surface 13 of the conduit 12 with the first liner 20, the second liner 30 may be inserted within the first liner 20 as shown in FIG. 4. The second liner 30 will be inserted within the first liner 20 such that the first seam 22 of the first liner 20 is offset with respect to the second seam 32 of the second liner 30. The same process described above for expanding and curing the first liner 20 may then be repeated with the second liner 30 to cure the second liner's 30 outer surface 35 against the inner surface 24 of the first liner 20.

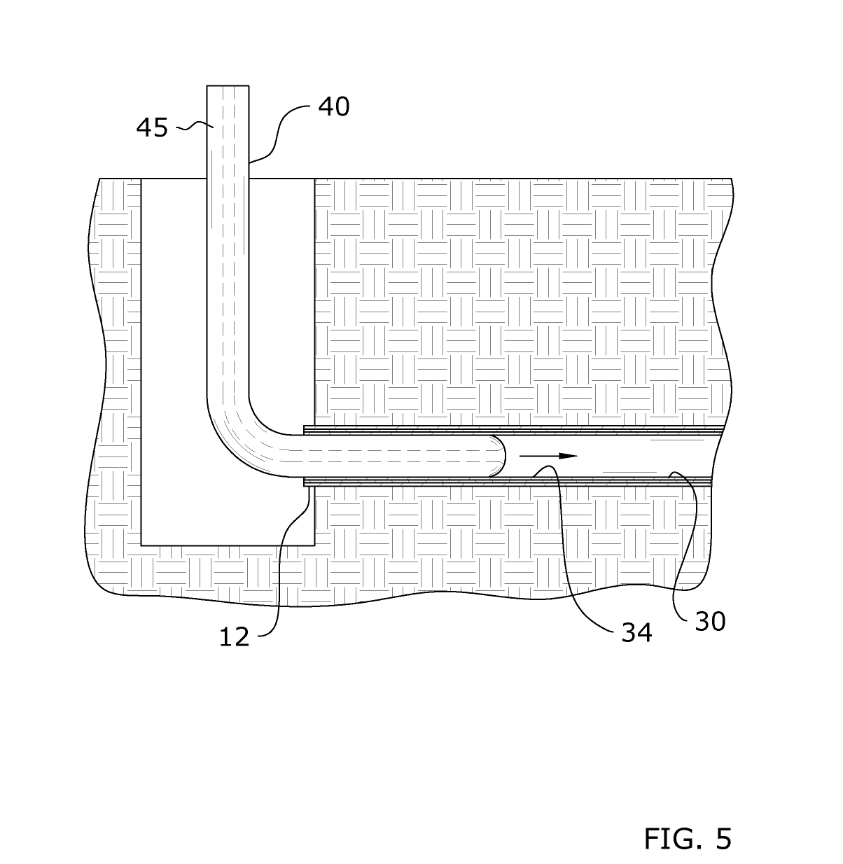

After sealing the inner surface 24 of the first liner 20 with the second liner 30, the third liner 40 may be inserted within the second liner 30 as shown in FIG. 5. The third liner 40 will be inserted within the second liner 30 such that the third seam 42 of the third liner 40 is offset with respect to the second seam 32 of the second liner 30 and the first seam 22 of the first liner 20. The same process for expanding and curing the first and second liners 20, 30 may then be repeated with the third liner 40 to cure the third liner's 40 outer surface 45 against the inner surface 34 of the second liner 30.

The same process may be repeated for any number of additional liners 20, 30, 40, with all of the seams 22, 32, 42 being offset with respect to each other to protect the structural integrity of the overall lining system 10. The present invention is particularly suitable for use with conduits 12 having bends, such as the 90 degree bend shown in FIGS. 7a, 7b, and 7c. Because multiple, thinner liners 20, 30, 40 are utilized, it is easier to install around such bends than if a single, thicker liner 20 was utilized.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A laminated pipe lining system, comprising:
a conduit;
a first liner sealed against an inner surface of said conduit, wherein said first liner includes a first seam; and
a second liner sealed against an inner surface of said first liner, wherein said second liner includes a second seam;
wherein said first seam is radially offset with respect to said second seam.

2. The laminated pipe lining system of claim 1, wherein said conduit is comprised of pressure piping.

3. The laminated pipe lining system of claim 1, wherein said first seam is radially offset by at least 20 degrees with respect to said second seam.

4. The laminated pipe lining system of claim 1, further comprising a third liner sealed against an inner surface of said second liner, wherein said third liner includes a third seal.

5. The laminated pipe lining system of claim 4, wherein said third seal is radially offset with respect to said first seam and said second seam.

6. The laminated pipe lining system of claim 5, wherein said third seal is radially offset by at least 20 degrees with respect to said second seam.

7. The laminated pipe lining system of claim 1, wherein said first liner and said second liner are each comprised of a textile material.

8. The laminated pipe lining system of claim 1, wherein said first liner and said second liner are each comprised of cylindrical tubes.

9. The laminated pipe lining system of claim 1, wherein said first liner and said second liner each extend for a full length of said conduit.

10. A method of installing layered liners within a pipe, comprising:
inserting a first liner through an interior of a conduit, wherein said first liner includes a first seam;
expanding said first liner against an inner surface of said conduit;
inserting a second liner through an interior of said first liner, wherein said second liner includes a second seam; and
expanding said second liner against an inner surface of said first liner, wherein said first seam is radially offset with respect to said second seam.

11. The method of installing layered liners within a pipe of claim 10, wherein said conduit includes at least one bend.

12. The method of installing layered liners within a pipe of claim 10, further comprising the step of curing said first liner to seal said first liner against said inner surface of said conduit.

13. The method of installing layered liners within a pipe of claim 12, further comprising the step of curing said second liner to seal said second liner against said inner surface of said first liner.

14. The method of installing layered liners within a pipe of claim 10, wherein said first seam is radially offset by at least 20 degrees with respect to said second seam.

15. The method of installing layered liners within a pipe of claim 10, further comprising the step of inserting a third liner through an interior of said second liner, wherein said third liner includes a third seam.

16. The method of installing layered liners within a pipe of claim 15, wherein said third seam is radially offset with respect to said first seam and said second seam.

17. The method of installing layered liners within a pipe of claim 16, further comprising the step of expanding said third liner against an inner surface of said second liner.

18. The method of installing layered liners within a pipe of claim 17, further comprising the step of curing said third liner to seal said third liner against said inner surface of said second liner.

19. The method of installing layered liners within a pipe of claim 18, wherein said first seam is radially offset by at least 20 degrees with respect to said second seam.

20. The method of installing layered liners within a pipe of claim 19, wherein said second seam is radially offset by at least 20 degrees with respect to said third seam.
